(19) United States
(12) Patent Application Publication
(10) Pub. No.: US 2023/0036679 A1
(43) Pub. Date: Feb. 2, 2023

(54) DOOR LOCKING SYSTEM

(71) Applicants: Michael Boyd, Heidelberg (DE); Fatos Uka, Bad Rappenau (DE)

(72) Inventors: Michael Boyd, Heidelberg (DE); Fatos Uka, Bad Rappenau (DE)

(73) Assignee: KARCHER GmbH, Bad Rappenau (DE)

(21) Appl. No.: 17/961,689

(22) Filed: Oct. 7, 2022

Related U.S. Application Data
(63) Continuation of application No. PCT/EP2021/058908, filed on Apr. 6, 2021.

(30) Foreign Application Priority Data
Apr. 9, 2020 (DE) 10 2020 204 648.4

(51) Int. Cl. E05B 9/08

(52) U.S. Cl. CPC E05B 9/08

(57) ABSTRACT

A door locking system includes two door handle units and a mounting device. The mounting device includes two mounting plates and two mounting pins. The mounting pins are fixed radially and axially in the mounting plates, and the mounting plates are secured coaxially at an axial distance. Each door handle unit is secured on the respective mounting plate, facing away from the mounting pins. Further, in the first mounting plate, two first openings are formed in which the two mounting pins are received. The first openings are formed by flaps pivoted to the mounting plate. The flaps can together be brought into a mounting position and into a blocking position by a blocking unit. In the mounting position, the flaps are freely pivotable, and in the blocking position, the flaps are pressed on toward the respective mounting pin by the blocking unit.

### CROSS-REFERENCE TO RELATED PATENT APPLICATIONS

This patent application is a continuation of International Application No. PCT/EP2021/058908, filed on Apr. 6, 2021, which claims the benefit of priority to German Patent Application No. 10 2020 204 648.4, filed Apr. 9, 2020, the entire teachings and disclosures of both applications are incorporated herein by reference thereto.

### FIELD

The present invention relates to a door locking system for opening and locking a door.

### BACKGROUND

A door locking system—as already disclosed for example in DE 20 2011 000 933 U1—usually includes a first door handle unit with a first door handle and a second door handle unit with a second door handle. The two door handle units are fixed to a door on both sides and are operatively connected to one another through the door by means of a pin with a polygonal cross-section. For fixing the door handle units to the door, mounting plates for the respective door handle units are first arranged on the door on both sides and through the door screwed to one another. Following this, the door handle units with the door handles are mounted to the mounting plates. Disadvantageously, such a mounting requires a lot of a user's time and effort. In particular, the mounting plates, the door handles, the pin with a polygonal cross-section and other elements of the door locking system have to be mounted to one another on site by the user.

### BRIEF SUMMARY

The object of the invention therefore is to state, for a door locking system of the generic type, an improved or at least alternative embodiment, with which the described disadvantages are overcome. In particular, the mounting of the door locking system is to be simplified.

According to the invention, this object is solved through the subject of the presently described embodiments.

A door locking system is provided for opening and for locking a door. The door locking system includes a first door handle unit and a second door handle unit. Further, the door locking system includes a mounting device, which comprises a first mounting plate, a second mounting plate and two mounting pins oriented along a mounting axis. The mounting pins are radially and axially fixed on the one side in the first mounting plate and on the other side in the second mounting plate and by way of this the mounting plates are fixed coaxially to one another and axially spaced apart from one another. The first door handle unit is fixed to the first mounting plate and the second door handle unit is fixed to the second mounting plate each facing away from the mounting pins. According to the invention, two first openings are formed in the first mounting plates, in which the two mounting pins are received. The two first openings are formed by a flap each in regions, which are pivotably fastened to the mounting plate transversely to the mounting axis. The respective flaps can be jointly brought into a mounting position and into a blocking position by means of a blocking unit of the mounting device. The respective flap is freely pivotable in the mounting position so that when axially introducing the respective mounting pin in the respective first opening its diameter is adapted to the diameter of the mounting pin. In the blocking position, the respective flap is pressed on towards the respective mounting pin by means of the blocking unit, so that the respective mounting pin is radially and axially fixed in the respective first opening.

When the door locking system is mounted to a door, the two mounting plates are arranged coaxially to one another and lying against the door on both sides. The two mounting pins pass through the door and non-rotatably connect the two mounting plates to one another. The mounting pins are non-slidably and non-rotatably arranged in the door or in a lock within the door transversely to the mounting axis, so that the mounting plates are also non-slidably and non-rotatably mounted on the door.

The door locking system can already be pre-assembled, wherein the first door handle unit can be fixed to the first mounting plate and the second door handle unit to the second mounting plate. The mounting pins can be fixed to the second mounting plate. Alternatively, the mounting pins can be integrally formed on the second mounting plate. When mounting the door locking system to the door, the flaps can be adjusted into the mounting position via the blocking unit and the mounting pins with the second mounting plate axially introduced through the door into the first openings of the first mounting plate. The diameter of the first openings is adapted by the flaps to the diameter of the mounting pins. When the mounting pins are received in the first openings, the flaps can be adjusted into the blocking position via the blocking unit and the mounting pins can be radially and axially fixed in the first openings. The mounting of the door locking system is advantageously reduced for a user to a sliding-together of the mounting plates and an adjusting of the blocking unit. The disassembly can be simplified in the same manner.

Practically, the blocking unit is formed so as to be accessible from the outside, so that the flaps in the finish-mounted door locking system are adjustable out of the mounting position into the blocking position and vice versa. Where the door locking system is mounted to an outside door, the locking unit and accordingly the first door handle unit and the first mounting plate have to be mounted from an inside. Because of this, interference with the door locking system via the blocking unit can be prevented. When the door system is mounted to an inside door, the blocking unit and accordingly the first door handle unit and the first mounting plate can be mounted from an inside and from an outside.

Advantageously it can be provided that within the respective first opening a thread and on the respective mounting pin a counter-thread are formed. In the blocking position of the respective flap, the thread is brought into engagement with the counter-thread. It is to be understood however that other models for the positive axial fixing of the mounting pins in the first openings can also be used. Preferentially, the thread is formed on the respective flap. When the flaps are pivoted out in the mounting position, the thread of the flap is not in the way of the counter-thread of the mounting pin when being axially introduced. In other words, when axially introducing the mounting pin, an undesirable interference between the thread and the counter-thread can be avoided. Further, the production of the mounting plate and because of this the door locking system as a whole can be simplified.

In an advantageous configuration of the door locking system it is provided that the first door handle unit includes a first cover plate oriented transversely to the mounting axis. The cover plate is fastened to the first mounting plate facing away from the mounting pins and pivotably fastened about the mounting axis into a blocking position and into a mounting position. The blocking unit is then formed on the first cover plate, wherein during the pivoting of the first cover plate into the blocking position, the two flaps are brought into the blocking position and during the pivoting of the first cover plate into the mounting position, the two flaps are brought into the mounting position. In other words, the blocking position of the cover plate corresponds to the blocking position of the flaps and the mounting position of the cover plate to the mounting position of the flaps.

The cover plate is accessible from the outside and, suitably simplified, can be adjusted between the mounting position and the blocking position. By way of the blocking unit on the cover plate, the mounting of the door locking system can be simplified. During the mounting of the door locking system to the door, the blocking unit or the first door handle unit have to be practically mounted on the inside in order to prevent an undesirable intervention in the door locking system via the blocking unit or the first door handle unit.

The first cover plate can be formed pot-shaped and axially and radially receive the first mounting plate. The cover plate can then circumferentially lie against the mounting plate on the outside at least in regions and during the pivoting between the blocking position and the mounting position be guided on the mounting plate. The cover plate can be configured so that in the mounting position the cover plate is detachable from the mounting plate and in the blocking position the cover plate is radially and axially fixed to the mounting plate.

Over-rotating of the cover plate on the mounting plate can be advantageously prevented by a stop unit. The stop unit can comprise at least one stop projection on the first cover plate and two stop points on the first mounting plate. The at least one stop projection of the stop plate is then arranged in the circumferential direction between the two stop points of the first mounting plate. In other words, the at least one stop projection and the two stop points overlap in the circumferential direction. The at least one stop projection, in the blocking position of the cover plate, can then lie against the one stop point of the mounting plate and in the mounting position of the cover plate against the other stop point of the mounting plate in the circumferential direction. Because of this, the first cover plate can be freely pivoted between the blocking position and the mounting position and an over-rotating of the cover plate can be prevented.

Advantageously it can be provided that the two flaps on the first mounting plate can be radially pivoted to the outside and the blocking unit is formed by two projections on the first cover plate directed radially to the inside. The projections on the first cover plate then interact radially with the flaps on the first mounting plate and, in the blocking position of the first cover plate, press the two flaps on towards the mounting pins. The cover plate can be radially and axially fixed to the first mounting plate in the blocking position by a radial press-fit connection between the projections and the flaps.

Advantageously it can be provided that the first cover plate can be fixed in the blocking position and in the mounting position by a detent unit. The detent unit can comprise for example a radially-resilient detent ball and two detent recesses, in which the detent ball alternately engages.

In an advantage further development of the door locking system it is provided that the first door handle unit comprises a first door handle. The first door handle is fixed to the first mounting plate so as to be pivotable into a locking position and into an opening position. The first door handle can be adjusted from the locking position into the opening position manually and from the open position into the locking position by means of a first resetting unit of the first door handle unit.

Preferentially, the first resetting unit can include a stop plate oriented transversely to the mounting axis having two radially oriented stop arms and two coil springs oriented in the circumferential direction. The stop plate is non-rotatably connected to the first door handle and the respective coil spring is supported, in the circumferential direction, on the one side on the respective stop arm of the first stop plate and on the other side on the first mounting plate. In the locking position of the first door handle, the coil spring of the first resetting unit is relaxed or only slightly tensioned. When the first door handle is manually pivoted into the open position, the radial stop arms pivot relative to the first mounting plate and the respective coil spring is tensioned. When the first door handle is released in the open position, the coil springs relax and the door handle pivots back into the locking position.

In an advantageous further development of the resetting unit, an optional mounting of the stop plate is provided. In a first position of the stop plate, the respective stop arm is adjacent to a first stop of the first mounting plate. The coil spring supports itself on the respective stop arm and on a second stop of the first mounting plate. In a second position of the stop plate, the respective stop arm is adjacent to the second stop of the first mounting plate. Then, the coil spring supports itself on the respective stop arm and on the first stop of the first mounting plate. The stop plate can then be optionally mounted in the first position or in the second position so that depending on the position of the stop plate the first door handle is pivotable out of the locking position into the open position in a first direction of rotation or in an opposite second direction of rotation. Advantageously, the door handle unit can be configured independently of the desired mounting position and the desired direction of rotation of the door handle. Because of this, the number of the individual parts in the door locking system is reduced.

Advantageously, the second door handle unit can comprise a second door handle which is identical to the first door handle of the first door handle unit. The first door handle and the second door handle are then non-rotatably connected to one another via an axially oriented pin with a polygonal cross-section and can be jointly pivoted about the mounting axis. In addition, the second door handle unit can comprise a secondary second unit, which is formed identical to the resetting unit of the first door handle unit. When the door locking system configured in such a manner is mounted to a door—for example an outside door or an inside door—and the door is not blocked by a further lock, the door can be opened on the inside and outside.

Advantageously, the second door handle unit can comprise a second cover plate which is formed in one piece with the second mounting plate. When mounting the door locking system, the second door handle unit can be mounted on the outside. When the door locking system configured in such a manner is mounted to a door—for example an outside door—the blocking unit is arranged on the inside and not accessible on the outside.

Advantageously, two second openings can be formed in the second mounting plate, into which the two mounting pins are screwed. Practically, a thread can be provided in the respective second opening and a counter-thread on the respective mounting pin, which are brought into engagement with one another. When the second cover plate and the second mounting plate are formed in one piece the two mounting pins can then be screwed into the second mounting plate facing away from the second cover plate.

Alternatively, the second door handle unit can comprise a second door handle which is non-pivotably fixed to the second mounting plate. When the door locking system configured in such a manner is mounted to a door, the door locking system can be opened from an inside by the first door handle and from an outside exclusively by a further device—such as for example electrically by way of an access card.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

### BRIEF DESCRIPTION OF THE DRAWINGS

Preferred exemplary embodiments of the invention are shown in the drawings and are explained in more detail in the following description, wherein same reference numbers relate to same or similar or functionally same components.

In the drawings:

FIG. 1 shows schematically a view of a door locking system according to the invention, which is being mounted to a door;

FIG. 2 shows schematically a view of the door locking system according to the invention, which is finish-mounted to the door;

FIG. 3 shows schematically a view of the door locking system according to the invention with a second door handle unit;

FIG. 4 shows schematically a view of the door locking system according to the invention with a first door handle unit shown partially in section with drawn-in region A;

FIG. 5 shows schematically a view of the first door handle unit from FIG. 4 with drawn-in region B, wherein a flap is positioned in a mounting position;

FIG. 6 shows schematically an enlarged view of the region B of the first door handle unit from FIG. 5;

FIG. 7 shows schematically a view of the first door handle unit from FIG. 4 with drawn-in region C, wherein the flap is positioned in a blocking position;

FIG. 8 shows schematically an enlarged view of the region C of the first door handle unit from FIG. 7; and

FIGS. 9 and 10 show schematically enlarged views of the region A of the first door handle unit from FIG. 4.

### DETAILED DESCRIPTION

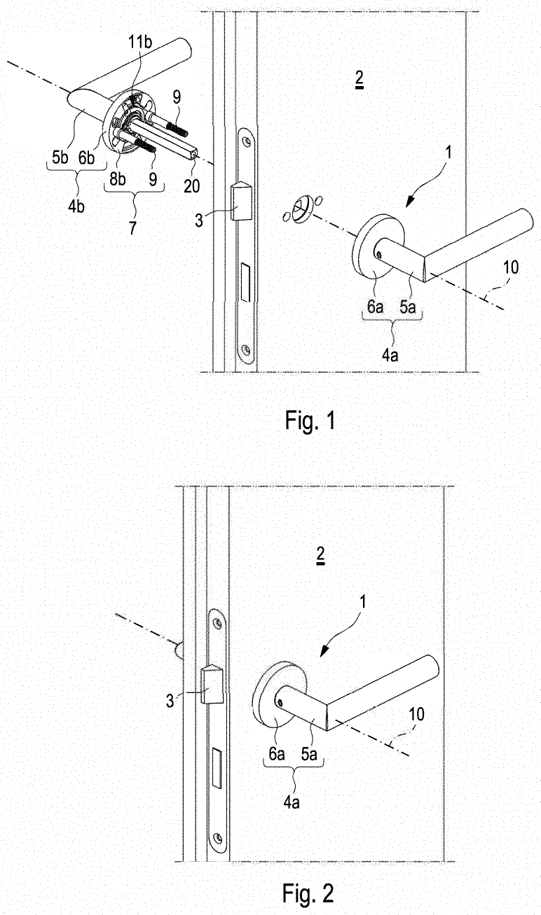

FIG. 1 shows a view of a door locking system 1 according to the invention while being mounted to a door 2. FIG. 2 shows a view of the finish-mounted door locking system 1. The door locking system 1 is provided for opening and for locking the door 2 and operatively connected to a lock 3 within the door 2. The door 2 and the lock 3 are not part of the present invention.

The door locking system 1 according to the invention comprises a first door handle unit 4a and a second door handle unit 4b. The first door handle unit 4a includes a first door handle 5a and a first cover plate 6a and the second door handle unit 4b includes a second door handle 5b and a second cover plate 6b. The two door handle units 4a and 4b are connected to one another through the door 2 by means of a mounting device 7. The mounting device 7 includes a first mounting plate 8a—not visible here—and a second mounting plate 8b, which are fixed to one another via two mounting pins 9. The door handles 5a and 5b is pivotable about a mounting axis 10 and the cover plates 6a and 6b are securely connected to mounting plates 8a and 8b. The cover plates 6a and 6b are pot-shaped and axially and radially receive the mounting plates 8a and 8b so that the mounting device 7 is not visible from the outside. By way of a pin 20 with a polygonal cross-section, the door handles 5a and 5b are non-rotatably connected to one another and additionally operatively connected to the lock 3. The door handles 5a and 5b can be manually adjusted from a locking position into an open position and automatically from the open position into the locking position. In the locking position of the door handles 5a and 5b—as shown here—the lock 3 is closed and in the open position of the door handles 5a and 5b, the lock 3 is open.

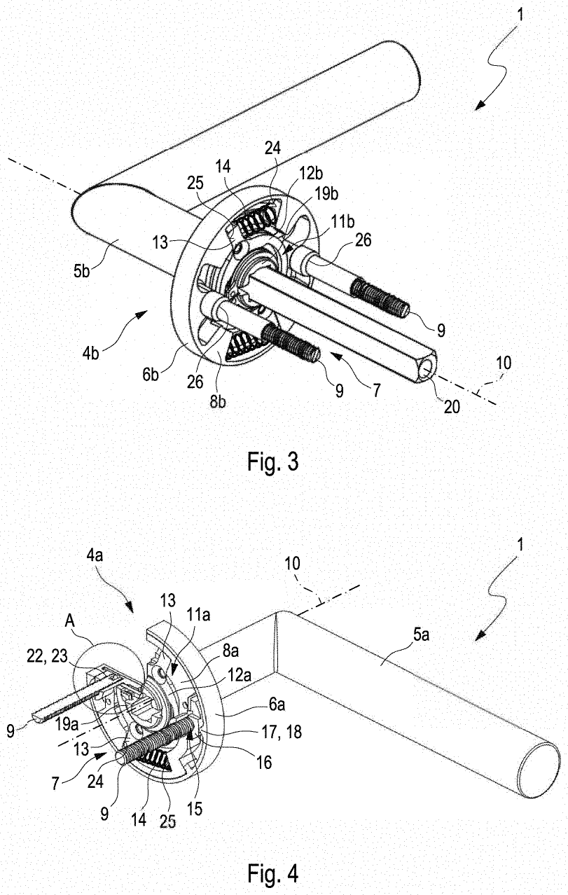

The door locking system 1 is mounted to the door 2 by means of the mounting device 7. To this end, the first mounting plate 8a—not visible here—with the pre-assembled first door handle unit 4a and the mounting plate 8b with the pre-assembled second door handle unit 4b are pushed along the mounting axis 10 and through the door 2 onto one another as shown in FIG. 1. The mounting pins 9 are fixed to the second mounting plate 8b and oriented to the first mounting plate 8a. During the mounting, the two mounting pins 9 are received in the first mounting plate 8a—not visible here—and subsequently fixed radially and axially. After the mounting, the two mounting plates 8a and 8b are oriented coaxially to the mounting axis 10 and fixed to the door 2 on both sides as shown in FIG. 2. Further details regarding the construction and regarding the mounting of the door locking system 1 are explained in more detail by way of FIG. 3 to FIG. 10.

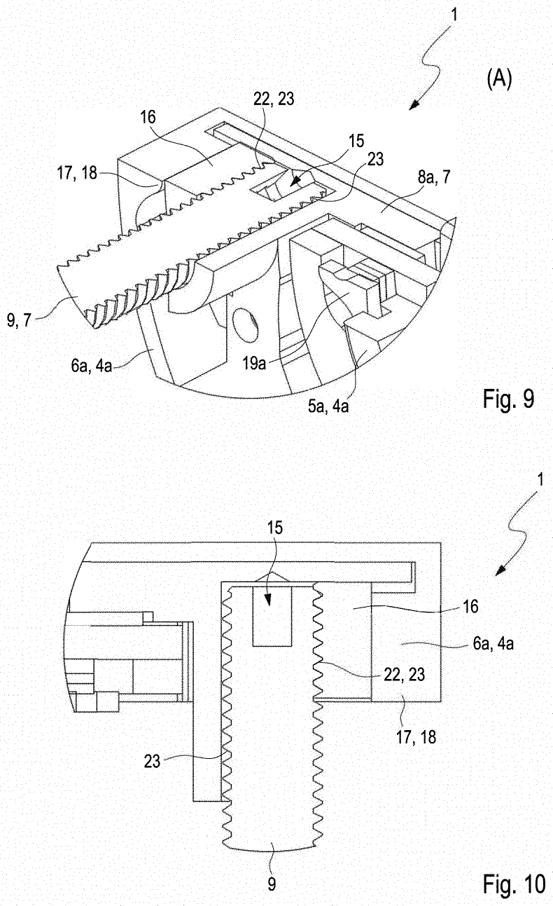

FIG. 3 shows a view of the second door handle unit 4b and partially of the mounting device 7 with the mounting pins 9. In FIG. 4, a partial sectional view of the first door handle unit 4a and partially of the mounting device 7 with the mounting pins 9 is shown. In FIG. 4, a region A is drawn in which is shown enlarged in FIG. 9.

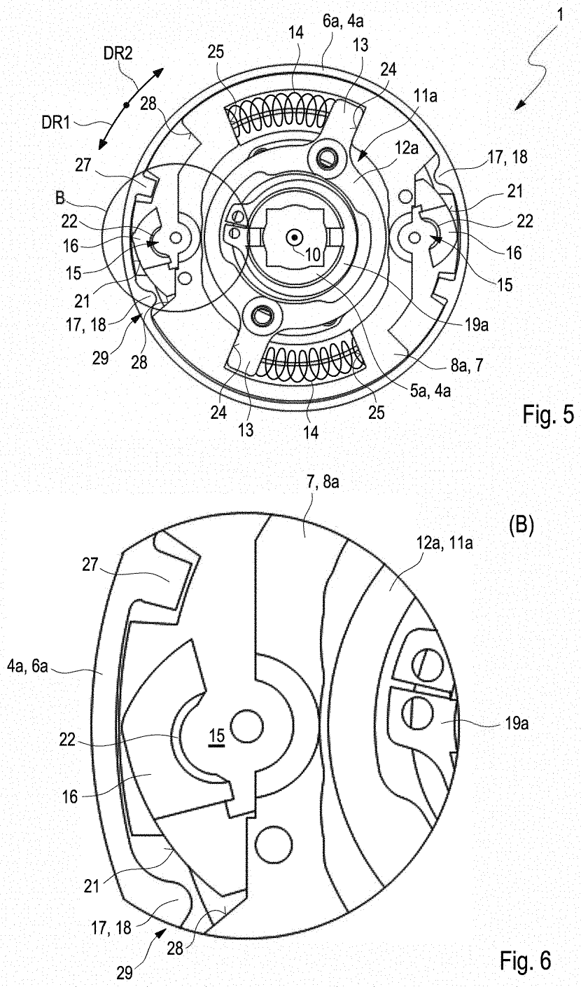

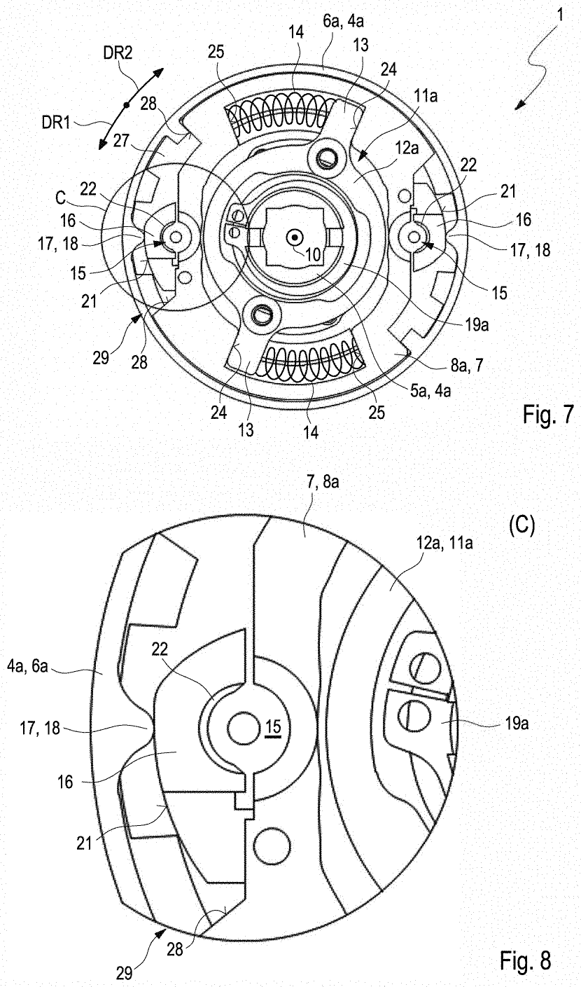

Making reference to FIG. 4, the first door handle unit 4a includes the door handle 5a and the cover plate 6a. By means of a first fixing ring the door handle 5a is fixed axially on the first mounting plate 8a and pivotably about the mounting axis 10. In addition, the first door handle unit 4a comprises a first resetting unit 11a which includes a stop plate 12a with two radially oriented stop arms 13 and with two coil springs 14 oriented in the circumferential direction. The construction of the resetting unit 11 is explained in more detail in the following by way of FIG. 5 and FIG. 7.

The first mounting plate 8a comprises two first openings 15 for the two mounting pins 9. The two first openings 15 are formed in regions by flaps 16, which are pivotably fastened to the mounting plate 8a transversely to the mounting axis 10 into a mounting position—see FIGS. 5 and 6 in this regard—and into a blocking position—see FIG. 7 and FIG. 8 in this regard. In the mounting position, the flaps 16 are freely pivotable so that the mounting pins 9 are slidable in the first openings 15. When the flaps 16 are adjusted into the mounting position, the two mounting plates 8a and 8b can be guided towards one another and apart from one another along the mounting axis 10. Accordingly, the door locking system 1 can be mounted to the door 2 or dismounted from the door 2. In the blocking position, the flaps 16 are pressed onto the mounting pins 9 by means of a blocking unit 17 and the mounting pins 9 are axially and radially fixed in the first openings 15. When the flaps 16 are adjusted into the blocking position, the two mounting plates 8a and 8b cannot be moved along the mounting axis 10. Accordingly, the door locking system 1 cannot be dismounted from the door 2. The blocking unit 17 is formed by two projections 18 on the first cover plate 6a. The construction of the blocking unit 17 and the interaction of the blocking unit 17 with the flaps 16 are explained in more detail in the following by way of FIG. 5 to FIG. 8.

Making reference to FIG. 3, the second door handle unit 4b comprises the second door handle 5b and the second cover plate 6b. By means of a second fixing ring 19b, the second door handle 5b is axially fixed to the second mounting plate 8 and pivotably about the mounting axis 10. In addition, the second door handle unit 4b comprises a second resetting unit 11b, which includes a second stop plate 12b with two radially oriented stop arms 13 and two coil springs 14 oriented in the circumferential direction. The door handles 5a and 5b, the fixing rings 19a and 19b and the resetting units 11a and 11b are formed identically to one another. In contrast with the first mounting plate 8a, the second mounting plate 8b comprises two second unchangeable openings 26 into which the mounting pins 9 are screwed and thus fixed axially and radially. The second cover plate 6b is additionally formed in one piece on the second mounting plate 8b. In the second door handle 5b, the pin 20 with a polygonal cross-section is received in a form-fitted manner, which following the mounting along the mounting axis 10 engages in the first door handle 5a in a form-fitted manner.

FIG. 5 now shows a view of the first door handle unit 4a transversely to the mounting axis 10. In FIG. 6, the drawn-in region B from FIG. 5 is shown enlarged. In FIG. 5 and FIG. 6, the first cover plate 6a is located in a mounting position and the flaps 16 of the first openings 15 in the corresponding mounting position. To this end, the first cover plate 6a is pivoted about the mounting axis 10 so that the projections 18 of the blocking unit 17 are not in engagement with the flaps 16. Because of this, the flaps 16 are freely pivotable so that the first openings 15 cannot change their diameter. Thus, when the first cover plate 6a is in the mounting position and the flaps 16 are in the mounting position, the mounting pins 9, during the mounting of the door locking system 1, can be axially introduced into the first openings 15 and during the dismounting of the door locking system 1, axially removed from the first openings 15. Advantageously, the cover plate 6a can be fixable in the mounting position by a detent unit—not shown here.

FIG. 7 now shows a view of the first door handle unit 4a transversely to the mounting axis 10. In FIG. 8, the drawn-in region C from FIG. 7 is shown enlarged. In FIG. 7 and FIG. 8, the first cover plate 6a is located in a blocking position and the flaps 16 of the first openings 15 in the corresponding blocking position. To this end, the first cover plate 6a is pivoted about the mounting axis 10 so that the projections 18 of the blocking unit 17 are in engagement with the flaps 16. When pivoting the cover plate 6a, the projections 18 are guided on ramps 21 of the flaps 16 until the flaps 16 are pressed against the mounting pins 9—not shown here—with sufficient force. In the first openings 15—here only on the flaps 16—threads 22 are formed which correspond to counter-threads 23 of the mounting pins 9. Thus, when the cover plate 6a is in the blocking position, the flaps 16 are pressed against the mounting pins 9 and the threads 22 are in engagement with the counter-threads 23. Because of this, the mounting pins 9 are axially and radially fixed in the first openings 15 and the dismounting of the door locking system 1 is not possible. Advantageously, the first cover plate 6a can be fixable in the blocking position by the abovementioned detent unit—not shown here.

In order to prevent over-rotating the cover plate 6a on the first mounting plate 8a, the door handle unit 4a comprises two stop units 29. The respective stop unit 29 each includes the one projection 18 and a further stop projection 27 on the first cover plate 6a and two stop points 28 each on the first mounting plate 8a. In the mounting position of the first cover plate 6a, the respective projections 18 and the respective stop points 28 are in engagement in the circumferential direction and in the blocking position of the first cover plate 6a, the respective stop projections 27 and the respective other stop points 28 are in engagement in the circumferential direction. The blocking position and the mounting position of the first cover plate 6a are thereby predefined. By way of the stop units 29, an over-rotating of the first cover plate 6a during the mounting can be prevented and thereby ensured that the flaps 16 are in fact situated in the blocking position.

FIG. 9 and FIG. 10 show enlarged views of the region A of the first door handle unit 4a from FIG. 4. Here, the blocking unit 17 on the cover plate 6a is adjusted into the blocking position and the flaps 16 are pressed against the mounting pins 9. As is also shown in FIG. 5 to FIG. 8, the thread 22 is only formed on the flaps 16. Because of this, the mounting pins 9 during the mounting can be introduced into the first openings 15 without obstacles and during the dismounting, removed from the first openings 15. With the mounted door locking system, the mounting pins 9 are nevertheless securely fixed in the first openings 15.

Making reference to FIG. 5 and FIG. 7, the resetting unit 11 a can be mounted in the first door handle unit 4a in two positions. The resetting unit 11 a—as already explained above—comprises the stop plate 12a with the stop arms 13 and with the coil springs 14.

In FIG. 5 and FIG. 7, the stop plate 12a is mounted in the first position. The respective stop arm 13 is adjacent to a first stop 24 of the first mounting plate 8a. The respective coil spring 14 supports itself on the respective stop arm 13 and on a second stop 25 of the first mounting plate 8a. Because of this, the door handle 5a can be manually adjusted from the open position into the locking position by way of the resetting unit 11a in an opposite second direction of rotation DR2. The directions of rotation DR1 and DR2 lie in a radial plane oriented transversely to the mounting axis 10 and circulate about the mounting axis 10.

In a second position of the stop plate 12a—not shown here—the respective stop arm 13 can be mounted adjacent to the second stop 25 of the first mounting plate 8a. The coil spring 14 then supports itself on the respective stop arm 13 on the first stop 24 of the first mounting plate 8a. Because of this, the door handle 5a can be manually adjusted from the locking position into the open position in the second direction of rotation DR2 and from the open position into the locking position by the resetting unit 11a in the first direction of rotation DR1.

Making reference to FIG. 3 and FIG. 4, the resetting units 11a and 11b are formed identically to one another and differ from one another by the position of the stop plates 12a and 12b. In the first door handle unit 4a, the stop plate 12a is mounted in the first position and in the second door handle unit 4b the stop plate 12b is mounted in the second position. Since the door handle units 4a and 4b are arranged transversely to the mounting axis 10 mirrored to one another, the door handles 5a and 5b can be jointly adjusted between the locking position and the open position in the respective direction of rotation DR1 and DR2.

In summary, the door locking system 1 according to the invention can be mounted and dismounted in a simplified manner. The mounting for a user is limited to sliding the mounting plates 8a and 8b together with the pre-assembled door handle units 4a and 4b and pivoting the cover plate 6a into the blocking position about the mounting axis 10. The disassembly can take place simplified in the same manner.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A door locking system for opening and for locking a door,
the door locking system comprising:
a first door handle unit;
a second door handle unit; and
a mounting device, the mounting device further comprising:
a first mounting plate;
a second mounting plate; and
two mounting pins oriented along a mounting axis,
wherein the mounting pins are radially and axially fixed on the one side in the first mounting plate and on the other side in the second mounting plate and by way of this the mounting plates are fixed coaxially to one another and axially spaced apart from one another,
wherein the first door handle unit is fixed to the first mounting plate and the second door handle unit to the second mounting plate in each case facing away from the mounting pins,
wherein in the first mounting plate two first openings are formed, in which the two mounting pins are received,
wherein the two first openings are formed by a flap each in regions, which are pivotably fastened to the mounting plate transversely to the mounting axis,
wherein the respective flaps can be jointly brought into a mounting position and into a blocking position by means of a blocking unit of the mounting device,
wherein in the mounting position the respective flap is freely pivotable, so that on axially introducing the respective mounting pin into the respective first opening its diameter is adapted to the diameter of the mounting pin, and
wherein in the blocking position the respective flap is pressed on towards the respective mounting pin by means of the blocking unit, so that the respective mounting pin is radially and axially fixed in the respective first opening.

2. The door locking system of claim 1,
wherein within the respective first opening, preferentially on the respective flap, a thread is formed, and on the respective mounting pin, a counter-thread is formed, and
wherein in the blocking position of the respective flap, the thread is brought into engagement with the counter-thread.

3. The door locking system of claim 1,
wherein the first door handle unit includes a first cover plate oriented transversely to the mounting axis, which is fastened to the first mounting plate facing away from the mounting pins so as to be pivotable about the mounting axis into a blocking position and into a mounting position, and
wherein the blocking unit is formed on the first cover plate, wherein when pivoting the first cover plate into the blocking position, the two flaps are brought into the blocking position and when pivoting the first cover plate into the mounting position, the two flaps are brought into the mounting position.

4. The door locking system of claim 3,
wherein the two flaps on the first mounting plate can be radially pivoted to the outside and the blocking unit is formed on the first cover plate by two projections directed radially to the inside, and
wherein the projections on the first cover plate radially interact with the flaps on the first mounting plate and in the blocking position of the first cover plate, press the two flaps on towards the mounting pins.

5. The door locking system of claim 3,
wherein the first cover plate in the blocking position and in the mounting position can be fixed by a detent unit.

6. The door locking system of claim 1,
wherein the first door handle unit comprises a first door handle, which is fixed to the first mounting plate so as to be pivotable into a closing position and into an open position, and
wherein the first door handle can be manually adjusted out of the closing position into the open position and out of the open position into the closing position by means of a first resetting unit of the first door handle unit.

7. The door locking system of claim 6,
wherein the first resetting unit includes a first stop plate oriented transversely to the mounting axis with two radially oriented stop arms, wherein the first stop plate is non-rotatably connected with the first door handle, and
wherein the first resetting unit includes two coil springs oriented in the circumferential direction, wherein the respective coil spring is supported in the circumferential direction on the one side on the respective stop arm of the first stop plate and on the other side on the first mounting plate.

8. The door locking system of claim 7,
wherein in a first position of the first stop plate the respective stop arm is adjacent to a first stop of the first mounting plate and the coil spring supports itself on the respective stop arm and on a second stop of the first mounting plate,
wherein in a second position of the first stop plate, the respective stop arm is adjacent to the second stop of the first mounting plate and the coil spring supports itself on the respective stop arm and on the first stop of the first mounting plate, and
wherein the first stop plate can be optionally mounted in the first position or in the second position, so that depending on the position of the first stop plate, the first door handle is pivotable from the locking position into the open position in a first direction of rotation (DR1) or in an opposite second direction of rotation (DR2).

9. The door locking system of claim 6,
wherein the second door handle unit comprises a second door handle, which is identical to the first door handle of the first door handle unit, and
wherein the second door handle unit comprises a second resetting unit, which is formed identically to the first resetting unit of the first door handle unit, and
wherein the first door handle and the second door handle are non-rotatably connected to one another via an axially oriented pin with a polygonal cross-section and are jointly pivotable about the mounting axis.

10. The door locking system of claim 9,
wherein the second door handle unit comprises a second cover plate, which is formed in one piece with the second mounting plate, and
wherein in the second mounting plate two second openings are formed, into which the two mounting pins are screwed.
